(19) United States
(12) Patent Application Publication
(10) Pub. No.: US 2023/0206011 A1
(43) Pub. Date: Jun. 29, 2023

(54) METHOD AND A SERVER FOR PERFORMING A CONTEXT-SPECIFIC TRANSLATION

(71) Applicant: YANDEX EUROPE AG, Luzem (CH)

(72) Inventors: Ilya Aleksandrovich GOLOVANOV, Dubna (RU); Georgy Viktorovich IVANOV, Moscow (RU); Aleksey Anatolevich NOSKOV, Kaluga (RU)

(21) Appl. No.: 18/087,110

(22) Filed: Dec. 22, 2022

(30) Foreign Application Priority Data
Dec. 24, 2021 (RU) 2021138713

(51) Int. Cl. G06F 40/58; G06F 40/284

(52) U.S. Cl. CPC G06F 40/58; G06F 40/284

(57) ABSTRACT

Methods and server for performing context-specific translation are disclosed. The method includes generating an augmented sequence of input tokens based on an input sentence in the first language and a given contextual word in the first language inserted into the input sentence. The given contextual word is represented as an input token in the augmented sequence of input tokens positioned at a pre-determined position and carrying contextual information. The method includes iteratively generating a sequence of output tokens based on the augmented sequence of input tokens, the sequence of output tokens including an output token positioned at a pre-determined position and represents the corresponding contextual word in the translated language, and an other first output token represents a context-specific translation of a given word in the input sequence.

### CROSS-REFERENCE

The present application claims priority to Russian Patent Application No. 2021138713, entitled “Method and a Server for Performing a Context-Specific Translation”, filed Dec. 24, 2021, the entirety of which is incorporated herein by reference.

### FIELD

The present technology relates to machine translation in general and, specifically, to a method and a server for performing a context-specific translation.

### BACKGROUND

With the growth of users accessing the Internet, a vast amount of Internet based services has surfaced. Such services include, for example, search engine services (such as Yandex™ and Google™ search engines, for example) that allow users to retrieve information by submitting queries to a search engine. Also, social network services as well as multimedia services enable a large variety of users with different social and cultural backgrounds to engage on unified platforms for exchanging content and information. Digital content and other information being exchanged amongst users may be in a variety of languages. For that reason, due to the ever-increasing amount of information being exchanged on the Internet, translation services such as Yandex.Translate™, for example, are often used.

The latter service has been particularly useful in allowing users to easily translate a text (or even a speech) from one language, which the user does not understand, into another one, which she does. This means that translation services are generally designed to provide a translated version of content in a language that the user understands to make that content intelligible for the user.

Translation engines are typically trained based on a large number of examples of parallel sentences between a source language and a target language. However, conventional computer systems providing translation services still have many drawbacks, such as providing correct translation of a rare word or a word specific to a particular domain.

US Patent application no. 2017/0323203 discloses systems and methods for neural machine translation.

### SUMMARY

Developers of the present technology have appreciated certain technical drawbacks associated with the existing translation services. It is an object of the present technology to ameliorate at least some of the inconveniences present in the prior art. Developers of the present technology have realized that translation models can be improved to provide better context-specific translation of sentences.

### Neural Machine Translation (NMT)

The use of Neural Networks (NNs) has allowed for significant advances in natural language processing and machine translation. NNs having “transformer” architectures can be used as translation models. This is due at least partially to the transformer architectures' ability to consider broad context introduced with Long Short-Term Memory (LSTM) networks and later, by the attention mechanism.

Broadly speaking, a NMT model observes during training a sequence X of input words Xi (each represented as one or more “input tokens”) in the source language and generates its translation Y consisting of output words Yᵢ (each represented as one or more “output tokens”). Training the NMT model requires sentences from a parallel corpus—i.e., a dataset that contains sentences in the source language and the corresponding translations in the destination/target language. The NMT model is generally trained to estimate the probability P(Yᵢ|X, Y_{0..i-1}) of observing an output word Yᵢ given the input sentence X and all previous output words Y_{0..i-1} using the maximum likelihood method, for example.

The translations are produced via a process called “decoding”. The goal of the decoding process of the NMT model is finding the most probable translation Y expressed as follows:

$$Y = arg {max}_{Y} P ( Y \vert X ) = {argmax}_{Y} {\sum }_{i} log P ( {Y}_{i} \vert X , {Y}_{0 … i - 1} ) \qquad ( 1 )$$

given the source sentence X as estimated by the NMT model. However, finding this translation exactly may be computationally intractable, so an approximation in the form of a “beam search” can be used instead. Broadly speaking, in computer science, beam search refers to a heuristic search algorithm that explores a graph by expanding the most promising node in a limited set, and where only a pre-determined number of best partial solutions are kept as candidates.

The translation can be generated iteratively one word at a time. At the start of each iteration, there are k translation prefixes, also referred to as hypotheses. The new top-k hypotheses ranked by respective probability are then selected out of all one-token continuations of previous k prefixes. If one of the selected continuations consists of a special “End-Of-Sequence” (EOS) token, it is considered complete and is excluded from the current top-k. The process can be stopped when the maximum probability of the current incomplete hypotheses is smaller than the probability of the current best complete hypothesis and/or when a pre-determined maximum number of iterations is reached.

Developers of the present technology have realized that some conventional NMT model suffer from poor quality when translating context-specific content. Developers have devised methods and systems where contextual information about one or more words in a sentence is “injected” into the translation process in a particular manner. More particularly, in the context of the present technology, a “contextual string” is inserted into a source sentence and carries contextual information about one or more words from the source sentence. The contextual information may thus be used by the NMT model when generating translations of the one or more words.

In some implementations of the present technology, the contextual string may be used for clarifying a topic associated with a source sentence. For example, let it be assumed that a source sentence in English is “The game is tomorrow”. It should be noted that the correct translation of the word “game” in Russian may be “ [symbol] ” or “ [symbol] ” and depends on a context in which the source sentence is used. In this example, the translation model may insert a contextual string “Soccer-” into the source sentence resulting in the following augmented source sentence “Soccer —The game is tomorrow”. As a result, the translation model may generate a following translation in Russian “ [symbol] -Mam [symbol] instead of “ [symbol] - [symbol] [symbol] ”. In this example, the contextual string inserted into the source sentence carries contextual information in a form of a topic-specific term and which is used by the translation model when translating the word “game”.

In other implementations of the present technology, the contextual string may be used for clarifying a gender of an entity in a source sentence. For example, let it be assumed that a source sentence in English is “The cat is hungry”. It should be noted that the correct translation of the word “cat” in Russian may be “ [symbol] κa” (feminine) or “ [symbol] ” (masculine), and the correct translation of the word “hungry” in Russian may be “ [symbol] (feminine) or “ [symbol] ” (masculine), depending on whether the specific animal referenced in the source sentence is female or male. The English language structure does not give clue to the gender of the subject due to the particularities of the English language structure. In this example, the translation model may insert a contextual string “She—” into the source sentence resulting in the following augmented source sentence “She—The cat is hungry”. As a result, the translation model may generate a following translation in Russian “oHa— [symbol] [symbol] ” instead of “ [symbol] - [symbol] [symbol] ”. In this example, the contextual string inserted into the source sentence carries contextual information in a form of a gender-specific term and which is used by the translation model when translating the word “cat”, as well as the word “hungry”.

The contextual string may be provided to the translation model in different ways. In some embodiments, a server may be configured to analyze one or more other sentences from a same paragraph in which the source sentence is found. In other embodiments, a server may access information about one or more words from a repository. In further embodiments, a plurality of contextual string candidates may be pre-stored, accessed by the server, and a specific candidate may be selected by the server for insertion into a given source sentence. The specific candidate may be selected based on information acquired by the server and/or extracted from an originating source of the given source sentence, without departing from the scope of the present technology.

Developers of the present technology have also realized that inserting the contextual string at the beginning of the sentence may be useful when processing the output from the translation model. It should be noted that inserting the contextual string at such a pre-determined position allows the translation model to identify which portion of the output sentence corresponds to the translation of the inserted contextual string and/or which other portion of the output sentence corresponds to the translation of the (non-augmented) source sentence. As a result, the portion of the output sentence corresponding to the translation of the inserted contextual string can be accurately removed from the target sentence to be provided as a translation of the (non-augmented) source sentence.

In a first broad aspect of the present technology, there is provided a method of performing context-specific translation of sentences from a first language to a second language. The method executable by a server. The server running a Neural Network (NN) and having access to a context-specific vocabulary containing contextual words in the first language and respective translations in the second language. The method comprises generating, by the server, an augmented sequence of input tokens based on an input sentence in the first language and a given contextual word in the first language inserted into the input sentence. The given contextual word is associated with a corresponding contextual word in the second language. The input sentence has a given word. The given word is represented as a first input token in the augmented sequence of input tokens. The given contextual word is represented as a second input token in the augmented sequence of input tokens. The second input token is positioned in the augmented sequence of input tokens at a pre-determined position and carries contextual information about the first input token. The method comprises iteratively generating, by the server using the NN, a sequence of output tokens based on the augmented sequence of input tokens. The sequence of output tokens includes a first output token and a second output token. The second output token is positioned in the sequence of output tokens at a pre-determined position and representing the corresponding contextual word in the second language. The first output token represents a context-specific translation of the given word.

In some embodiments of the method, the first input token is a sub-sequence of input tokens. The given word is represented by the sub-sequence of input tokens in the augmented sequence of input tokens.

In some embodiments of the method, the first output token is an other sub-sequence of input tokens. The context-specific translation of the given word is represented by the other sub-sequence of input tokens.

In some embodiments of the method, the input sentence is a given one from a plurality of sentences in a digital document. The method further comprises determining, by the server, the given contextual word based on an other given one from the plurality of sentences.

In some embodiments of the method, the method further comprises determining, by the server, the given contextual word based on data pre-stored in association with one or more words from the input sentence.

In some embodiments of the method, the method comprises accessing, by the server, the context-specific vocabulary for identifying the given contextual word in the first language and the corresponding contextual word in the second language.

In some embodiments of the method, the method further comprises generating, by the server, an output sentence in the second language using the sequence of output tokens.

In some embodiments of the method, the generating the output sentence comprises removing the corresponding contextual word.

In some embodiments of the method, the pre-determined position in the augmented sequence of input tokens is a position preceding input tokens representing the input sentence.

In some embodiments of the method, the pre-determined position in the augmented sequence of input tokens is at a beginning of the augmented sequence of input tokens.

In some embodiments of the method, the pre-determined position in the sequence of output tokens is at a beginning of the sequence of output tokens.

In some embodiments of the method, the NN is a transformer model. The transformer model has an encoder portion dedicated to the first language and a decoder portion dedicated to the second language.

In some embodiments of the method, the contextual information represents a gender of the given input word.

In some embodiments of the method, the contextual information represents a topic of the input sentence including the given input word.

In a second broad aspect of the present technology, there is provided a server for performing context-specific translation of sentences from a first language to a second language. The server is running a Neural Network (NN) and has access to a context-specific vocabulary containing contextual words in the first language and respective translations in the second language. The server is configured to generate an augmented sequence of input tokens based on an input sentence in the first language and a given contextual word in the first language inserted into the input sentence. The given contextual word is associated with a corresponding contextual word in the second language. The input sentence has a given word. The given word is represented as a first input token in the augmented sequence of input tokens. The given contextual word is represented as a second input token in the augmented sequence of input tokens. The second input token is positioned in the augmented sequence of input tokens at a pre-determined position and carries contextual information about the first input token. The server is configured to iteratively generate, using the NN, a sequence of output tokens based on the augmented sequence of input tokens. The sequence of output tokens includes a first output token and a second output token. The second output token is positioned in the sequence of output tokens at a pre-determined position and represents the corresponding contextual word in the second language. The first output token represents a context-specific translation of the given word.

In some embodiments of the server, the first input token is a sub-sequence of input tokens. The given word is represented by the sub-sequence of input tokens in the augmented sequence of input tokens.

In some embodiments of the server, the first output token is an other sub-sequence of input tokens. The context-specific translation of the given word is represented by the other sub-sequence of input tokens.

In some embodiments of the server, the input sentence is a given one from a plurality of sentences in a digital document. The server is further configured to determine the given contextual word based on an other given one from the plurality of sentences.

In some embodiments of the server, the server is further configured to determine the given contextual word based on data pre-stored in association with one or more words from the input sentence.

In some embodiments of the server, the server is configured to access the context-specific vocabulary for identifying the given contextual word in the first language and the corresponding contextual word in the second language.

In some embodiments of the server, the server is further configured to generate an output sentence in the second language using the sequence of output tokens.

In some embodiments of the server, to generate the output sentence comprises the server configured to remove the corresponding contextual word.

In some embodiments of the server, the pre-determined position in the augmented sequence of input tokens is a position preceding input tokens representing the input sentence.

In some embodiments of the server, the pre-determined position in the augmented sequence of input tokens is at a beginning of the augmented sequence of input tokens.

In some embodiments of the server, the pre-determined position in the sequence of output tokens is at a beginning of the sequence of output tokens.

In some embodiments of the server, the NN is a transformer model, the transformer model having an encoder portion dedicated to the first language and a decoder portion dedicated to the second language.

In some embodiments of the server, the contextual information represents a gender of the given input word.

In some embodiments of the server, the contextual information represents a topic of the input sentence including the given input word.

In the context of the present specific, a “transformer” model is a model having an encoder-decoder architecture that employs attention mechanisms. Attention mechanisms may be employed during processing of data by the encoder, during processing of data by the decoder, and during encoder-decoder interactions. A variety of attention mechanisms may be employed as part of a transformer model.

Self-attention may be one of the components of the transformer model. The difference between attention mechanism and self-attention mechanism is that self-attention operates between representations of the same nature: e.g., all encoder states in some layer. Self-attention mechanism is a part of the transformer model where tokens interact with each other. Each token in a sense “looks” at other tokens in the sentence with an attention mechanism, gathers context, and updates the previous representation of “self”. Each input token in a self-attention mechanism receives three representations: (i) query, (ii) key, and (ii) value. The query is used when a token looks at others—it's seeking the information to understand itself better. The key is responding to a query's request: it is used to compute attention weights. The value is used to compute attention output: it gives information to the tokens which “say” they need it (i.e. assigned large weights to this token).

Masked self-attention may be an other one of the components of the transformer model. The decoder usually includes this particular self-attention mechanism and which is different from the self-attention mechanism in the encoder. While the encoder receives all tokens at once and the tokens can look at all tokens in the input sentence, in the decoder, tokens are generated one at a time—during generation, the model does not know which tokens will be generated in future. To forbid the decoder to “look ahead”, the transformer model uses masked self-attention—i.e., future tokens are masked out.

Multi-head attention is a further one of the components of the transformer model. It should be noted that understanding the role of a word in a sentence requires understanding how it is related to different parts of the sentence. This is important not only in processing source sentence but also in generating targets. As a result, this type of attention mechanism may allow the transformer model to “focus of different things”. Instead of having one attention mechanism, multi-head attention has several “heads” which work independently. This may be implemented as several attention mechanisms whose results are combined.

The encoder of the transformer model can include an encoder self-attention mechanism and a feedforward network block. The encoder self-attention mechanism may be a multi-head attention mechanism used for tokens to “look” at each other. The queries, keys, values are computed from encoder states. The feedforward network block receives the information from tokens and processes that information.

The decoder of the transformer model can include a decoder self-attention mechanism (masked), a decoder-encoder attention mechanism, and a feedforward network. The decoder masked self-attention mechanism may be a masked multi-head attention mechanism used for tokens to “look” at previous tokens. The queries, keys, values are computed from decoder states. The decoder-encoder attention mechanism may be a multi-head attention mechanism used for target tokens to “look” at the source information. Queries are computed from decoder states, while keys and values are computed from encoder states. The feedforward network block receives the information from tokens and processes that information.

It can be said that in the encoder, tokens communicate with each other and update their representations. It can also be said that in the decoder, a target token first looks at previously generated target tokens, then at the source, and finally updates its representation. This can be repeated in several layers. In one non-limiting implementation, this can be repeated 6 times.

As mentioned above, in addition to an attention mechanism, a given layer has a feedforward network block. For example, the feedforward network block may be represented by two linear layers with a ReLU non-linearity between them. After looking at other tokens via an attention mechanism, a model uses a feedforward network block to process this new information. The transformer model may further comprise residual connections for adding a block's input to its output. Residual connections may be used for stacking layers. In a transformer model, residual connections can be used after a respective attention mechanism and feedforward network block. For example, an “Add & Norm” layer may be provided with (i) the input of an attention mechanism via a residual connection and (ii) the output of the attention mechanism. The result of this Add & Norm layer may then be provided to a feedforward network block or another attention mechanism. In another example, an “Add & Norm” layer may be provided with (i) the input of an feedforward network block via a residual connection and (ii) the output of the feedforward network block. As alluded to above, the transformer model may comprise Add & Norm layers. Broadly speaking, such a layer can independently normalize vector representation of each example in a batch—this is done to control “flow” to the next layer. Layer normalization may improve convergence stability and sometimes even quality.

In the context of the present specification, a “server” is a computer program that is running on appropriate hardware and is capable of receiving requests (e.g., from client devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “client device” is any computer hardware that is capable of running software appropriate to the relevant task at hand. Thus, some (non-limiting) examples of client devices include personal computers (desktops, laptops, netbooks, etc.), smartphones, and tablets, as well as network equipment such as routers, switches, and gateways. It should be noted that a device acting as a client device in the present context is not precluded from acting as a server to other client devices. The use of the expression “a client device” does not preclude multiple client devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, lists of words, etc.

In the context of the present specification, the expression “component” is meant to include software (appropriate to a particular hardware context) that is both necessary and sufficient to achieve the specific function(s) being referenced.

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 depicts a system suitable for implementing non-limiting embodiments of the present technology.

FIG. 2 depicts a representation of a conventional translation model for generating a sequence of output tokens.

FIG. 3 depicts a representation of data stored in a database of the system of FIG. 1, in accordance with some non-limiting embodiments of the present technology.

FIG. 4 depicts a representation of an augmented training example being generated by a server of the system of FIG. 1, in accordance with some non-limiting embodiments of the present technology.

FIG. 5 depicts a training iteration a translation model of the system of FIG. 1, in accordance with some non-limiting embodiments of the present technology.

FIG. 6 depicts an in-use iteration of the translation model of FIG. 5, in accordance with some non-limiting embodiments of the present technology.

FIG. 7 is a schematic flowchart of a method executable in accordance with certain non-limiting embodiments of the present technology.

### DETAILED DESCRIPTION

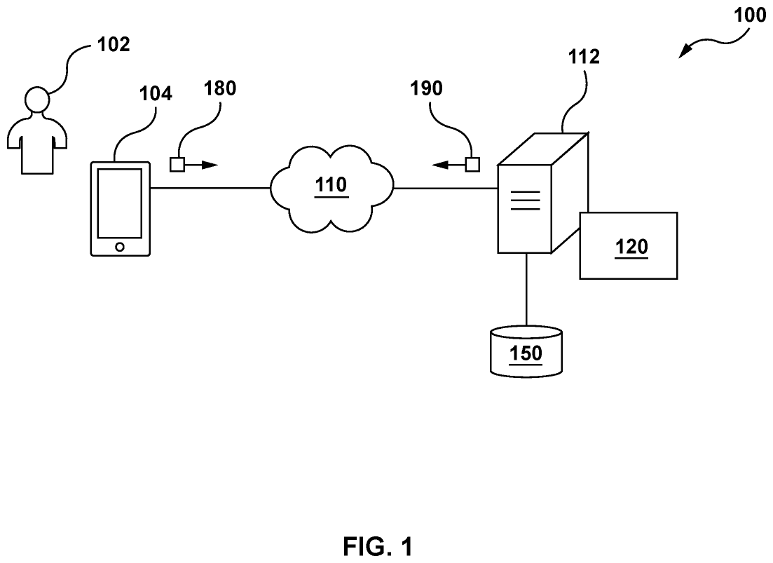

Referring to FIG. 1, there is shown a schematic diagram of a system 100, the system 100 being suitable for implementing non-limiting embodiments of the present technology. It is to be expressly understood that the system 100 as depicted is merely an illustrative implementation of the present technology. Thus, the description thereof that follows is intended to be only a description of illustrative examples of the present technology. This description is not intended to define the scope or set forth the bounds of the present technology. In some cases, what are believed to be helpful examples of modifications to the system 100 may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e., where no examples of modifications have been set forth), it should not be interpreted that no modifications are possible and/or that what is described is the sole manner of implementing that element of the present technology. As a person skilled in the art would understand, this is likely not the case. In addition it is to be understood that the system 100 may provide in certain instances simple implementations of the present technology, and that where such is the case they have been presented in this manner as an aid to understanding. As persons skilled in the art would understand, various implementations of the present technology may be of a greater complexity.

Generally speaking, the system 100 is configured to provide electronic translation services for a user 102 of an electronic device 104. For example, the system 100 may be configured to acquire a sentence in a source language, and provide a translated version of that sentence in a target language. At least some components of the system 100 will now be described, however, it should be understood that other components to those depicted in FIG. 1 may be part of the system 100 without departing from the scope of the present technology.

### Communication Network

The electronic device 104 is communicatively coupled to a communication network 110 for communication with the server 112. For example, the electronic device 104 may be communicatively coupled with the server 112 via the communication network 110 for providing the user 102 with the translation services. The communication network 110 is configured to transmit inter alia requests and responses between the electronic device 104 and the server 112 in a form of one or more data packets comprising communication data.

In some non-limiting embodiments of the present technology, the communication network 110 can be implemented as the Internet. In other non-limiting embodiments of the present technology, the communication network 110 can be implemented differently, such as any wide-area communication network, local-area communication network, a private communication network and the like. How a communication link (not separately numbered) between the electronic device 104 and the communication network 110 is implemented will depend inter alia on how the electronic device 104 is implemented.

Merely as an example and not as a limitation, in those embodiments of the present technology where the electronic device 104 is implemented as a wireless communication device (such as a smartphone), the communication link can be implemented as a wireless communication link (such as but not limited to, a 3G communication network link, a 4G communication network link, Wireless Fidelity, or WiFi® for short, Bluetooth® and the like). In those examples where the electronic device 104 is implemented as a notebook computer, the communication link can be either wireless (such as Wireless Fidelity, or WiFi® for short, Bluetooth® or the like) or wired (such as an Ethernet based connection).

### Electronic Device

The system 100 comprises the electronic device 104, the electronic device 104 being associated with the user 102. As such, the electronic device 104 can sometimes be referred to as a “client device”, “end user device”, “client electronic device” or simply “device”. It should be noted that the fact that the electronic device 104 is associated with the user 102 does not need to suggest or imply any mode of operation—such as a need to log in, a need to be registered, or the like.

The implementation of the electronic device 104 is not particularly limited, but as an example, the electronic device 104 may be implemented as a personal computer (desktops, laptops, netbooks, etc.), a wireless communication device (such as a smartphone, a cell phone, a tablet and the like), as well as network equipment (such as routers, switches, and gateways). The electronic device 104 comprises hardware and/or software and/or firmware (or a combination thereof), as is known in the art, to execute a browser application.

Generally speaking, the purpose of the browser application is to enable the user 102 to access one or more network resources, such as web pages, for example. How the browser application is implemented is not particularly limited. One example of the browser application may be embodied as a Yandex™ browser.

The user 102 may use the browser application for accessing a translation engine for translating one or more sentences from a source language to a target language. For example, the electronic device 104 may be configured to generate a request indicative of one or more sentences that the user 102 desires to be translated. Also, the electronic device 104 may be configured to receive a response (not depicted) for displaying a translated version of one or more sentences in the target language to the user 102. Typically, the request and the response may be transmitted from and to the electronic device 104 via the communication network 110.

### Database

The system 100 also comprises a database 150 which is communicatively coupled to the server 112 and is configured to store information extracted or otherwise determined or generated by the server 112. Generally speaking, the database 150 may receive data from the server 112 which was extracted or otherwise determined or generated by the server 112 during processing for temporary and/or permanent storage thereof and may provide stored data to the server 112 for use thereof. It is contemplated that the database 150 may be split into several distributed databases without departing from the scope of the present technology.

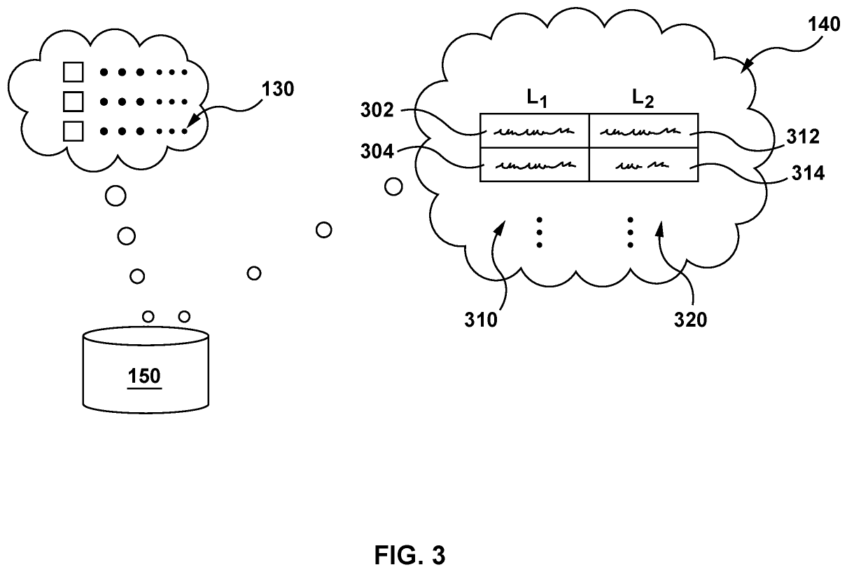

The database 150 may be configured to store data for supporting translation services providable by the translation engine of the server 112. To that end, the database 150 may store inter alia a context-specific vocabulary 140 and a plurality of training examples 130 as depicted in FIG. 3.

Broadly speaking, the context-specific vocabulary 140 is a data structure comprising contextual strings 310 in a first language and corresponding contextual strings 320 in a second language. In the illustrated non-limiting example, the contextual strings 310 in the first language include a contextual string 302 and a contextual string 304, and the contextual strings 310 in the second language include a contextual string 312 and a contextual string 314. The contextual string 312 is a translation of the contextual string 302 into the second language. The contextual string 314 is a translation of the contextual string 304 into the second language.

In one implementation of the present technology, the context-specific vocabulary 140 may include one or more of the following pairs of contextual strings for the English-Russian language pair:
“She—”& “ [symbol] —”;
“He—”& “ [symbol] —”;
“She:” & “ [symbol] :”;
“She said/” & “oHa [symbol] ”.;
“Weather—” & “ [symbol] —”; and
“Soccer—” & “ [symbol] —”

In some embodiments of the present technology, it is contemplated that a given context-specific vocabulary may comprise translations of a given contextual string in more than one second languages without departing from the scope of the present technology. It can be said that the data structure may be bi-lingual, tri-lingual, and so forth. In other embodiments of the present technology, it is contemplated that a given contextual string may include one word, while an other given contextual string may include two or more words. Optionally, a given contextual string may include a combination of words and other special characters such as “-”, “;”, “:”, “I”, “#”, “@”, “*”, “&”, and the like.

Additionally, or alternatively, the database 150 may store a plurality of context-specific vocabularies, similar to the context-specific vocabulary 140, each of which is associated with a respective type of context. For example, the context-specific vocabulary 140 may include pairs of gender-specific contextual strings, while an other context-specific vocabulary may include pairs of topic-specific contextual strings.

As mentioned above, the database 150 may further comprise the plurality of training examples 130 for training one or more MLAs included in the translation engine of the server 112. The plurality of training examples 130 may include a large number of parallel sentences, where each pair of parallel sentences includes a first one in the first language and a second one in the second language. It is also contemplated that a respective plurality of training examples may be stored for respective source-target pair of languages, without departing from the scope of the present technology. The parallel sentences may be identified from one or more text sources and the identification of parallel sentences is not particularly limited. How the plurality of training examples 130 may be employed by the server 112 during training of one or more MLAs will be described in greater detail herein further below.

### Server

The system 100 also comprises the server 112 that can be implemented as a conventional computer server. In the depicted non-limiting embodiments of the present technology, the server 112 is a single server. In alternative non-limiting embodiments of the present technology, functionalities of the server 112 may be distributed and may be implemented via multiple servers. The server 112 may include one or more processors, one or more non-transitory memory devices, computer-readable instructions, and/or additional hardware components, additional software components, and/or combination thereof, for implementing various functionalities of the server 112, without departing from the scope of the present technology.

Generally speaking, the server 112 can be under control and/or management of a translation service provider (not depicted), such as, for example, an operator of Yandex™ translation services. It is contemplated that the provider of the translation services and the provider of the browser application may be the same provider. For example, the browser application (e.g., Yandex™ browser) and the translation services (e.g., Yandex™ translation services) may be provided, controlled and/or managed by the same operator or entity.

As mentioned above, the server 112 hosts a translation engine (not depicted). Broadly speaking, the translation engine is embodied as a plurality of computer-implemented procedures that are used for translating one or more sentences from a source language into a target language and providing the translations to users of the translation engine. To that end, the server 112 is configured to execute a translation model 120.

### Machine Learning Algorithms

Generally speaking, MLAs can learn from training samples and make predictions on new (unseen) data. The MLAs are usually used to first build a model based on training inputs of data in order to then make data-driven predictions or decisions expressed as outputs, rather than following static computer-readable instructions.

The MLAs are commonly used as estimation models, translation models, classification models and the like. It should be understood that different types of the MLAs having different structures or topologies may be used for various tasks.

One particular type of MLAs includes Neural Networks (NNs). Generally speaking, a given NN consists of an interconnected group of artificial “neurons”, which process information using a connectionist approach to computation. NNs are used to model complex relationships between inputs and outputs (without actually knowing the relationships) or to find patterns in data. NNs are first conditioned in a training phase in which they are provided with a known set of “inputs” and information for adapting the NN to generate appropriate outputs (for a given situation that is being attempted to be modelled). During this training phase, the given NN adapts to the situation being learned and changes its structure such that the given NN will be able to provide reasonable predicted outputs for given inputs in a new situation (based on what was learned). Thus rather than trying to determine complex statistical arrangements or mathematical algorithms for a given situation; the given NN tries to provide an “intuitive” answer based on a “feeling” for a situation.

NNs are commonly used in many such situations where it is only important to know an output based on a given input, but exactly how that output is derived is of lesser importance or is unimportant. For example, NNs are commonly used to optimize the distribution of web-traffic between servers, automatic text translation into different languages, data processing, including filtering, clustering, vector embedding, and the like.

Furthermore, the implementation of a given MLA can be broadly categorized into two phases—a training phase and an in-use phase. First, the given MLA is trained in the training phase. Then, once the given MLA knows what data to expect as inputs and what data to provide as outputs, the given MLA is actually run using in-use data in the in-use phase.

It is contemplated that the translation model 120 may be a Neural Machine Translation (NMT) model having a transformer architecture. Broadly speaking, a transformer model or simply “transformer” is a deep learning model that adopts the mechanism of attention and may differentially weigh the significance of each part of the input data.

Similar to some other models, the transformer adopts an encoder-decoder architecture. The encoder consists of encoding layers that process the input iteratively one layer after another, while the decoder consists of decoding layers the encoder's output iteratively one layer after another. The function of each encoder layer is to generate encodings that contain information about which parts of the inputs are relevant to each other. It passes its encodings to the next encoder layer as inputs. Each decoder layer can be said to do the “opposite”, taking all the encodings and using their incorporated contextual information to generate an output sequence. To achieve this, encoder and decoder layers make use of attention mechanisms.

Generally, for a given input, an attention mechanism weighs the relevance of other inputs and draws from them to produce the output. Also, each decoder layer may have an additional attention mechanism that draws information from the outputs of previous decoders, before the decoder layer draws information from the encodings. It is contemplated that both the encoder and decoder layers may have a feed-forward NN for additional processing of the outputs, and contain residual connections and layer normalization steps.

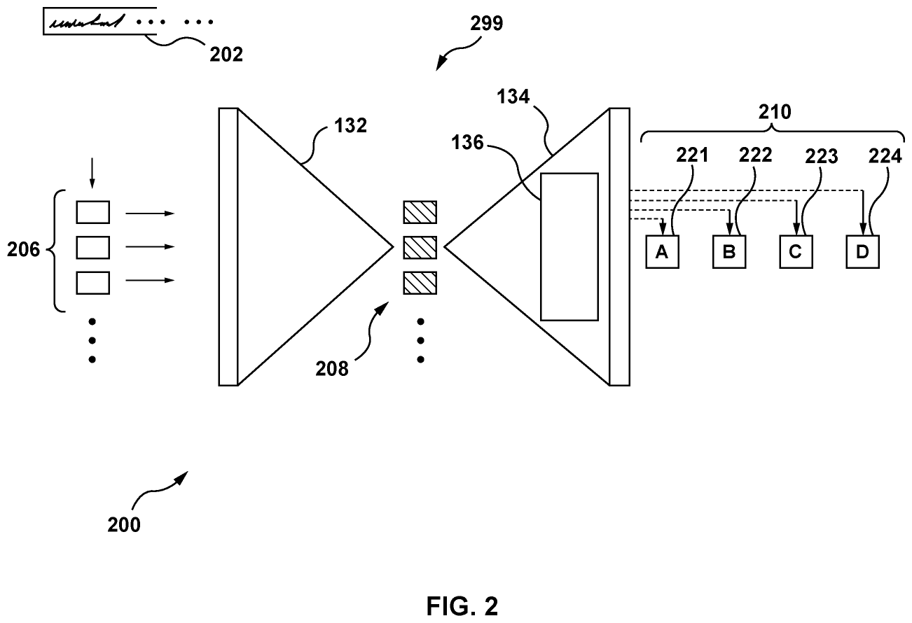

With reference to FIG. 2, there is depicted an encoder portion 132 (or simply “encoder”) and a decoder portion 134 (or simply “decoder”) of a transformer model 299. Broadly speaking, the encoder 132 receives a sequence of input tokens generated based on text in the source language and produces a compact representation of that input sequence, trying to summarize or condense all of its information. These compact representations are received by the decoder portion 134, and which can also receive other external inputs. At each step, the decoder portion 134 generates an element of its output sequence (an output token) based on the inputs received, and can update its own state for the next step where an other element of the output sequence is generated (a next output token).

The decoder portion 134 can be implemented with an attention mechanism 136. The attention mechanism 136 can be implemented via an attention layer that allows the decoder portion 134 to, in a sense, “attend” to particular information during output generation as it will be described herein further below.

In some cases, the decoder portion 134 may be a “greedy” decoder. For example, the decoder portion 134 may be configured to generate a given output sequence representative of a word in a target language and which has the highest probability of being a translation of respective word in a source language. It is contemplated that a beam search algorithm may be used during the decoding process.

The source sentence 202 may be split into a sequence of input tokens 206. The input tokens may be provided to the encoder portion 132. The encoder portion 132 is configured to generate hidden vector representations based on the inputted tokens. For example, the electronic device 104 employing the encoder portion 132 may be configured to generate a vector representations 208 for the sequence of input tokens 206.

Vector representations may be provided to the decoder portion 134. The decoder portion 134 is configured to generate output tokens based on inter alia vector representations generated by the encoder portion 132 and other inputs, such as previously generated output tokens, for example. Output tokens generated by the decoder portion 134 may be used for providing a translation of the source sentence 202 (i.e., a target sentence) to the user 102.

The decoder portion 134 is configured to use the sequence of vector representations 208 for generating a first output token 221. At the next step, the decoder portion 134 is configured to further use the first output token 221 (additional input) for generating a second output token 222. At the next step, the decoder portion 134 is configured to further use the second output token 222 (additional input) for generating a third output token 223. At the next step, the decoder portion 134 is configured to further use the third output token 223 (additional input) for generating a fourth output token 224, and so forth.

As previously alluded to, the electronic device 104 may make use of the attention mechanism 136 for taking into account previous output tokens generated by the decoder portion 134 for generating a current output token in a sequence of output tokens. In some embodiments, the decoder portion 134 may be configured to use one or more output tokens generated by the decoder portion 134 and which are associated with the current and/or previous words generated by the decoder portion 134.

The decoder portion 134 generates a sequence of output tokens 210 based on inter alia the vector representations 208 as well as previous output tokens in the sequence of output tokens 210 for generating a current output token from the sequence of output tokens 210.

Developers of the present technology have realized that some conventional NMT model suffer from poor quality when translating context-specific content. Developers have devised methods and systems where contextual information about one or more words in a sentence is “injected” into the translation process in a particular manner. More particularly, in the context of the present technology, a “contextual string” is inserted into a source sentence and carries contextual information about one or more words from the source sentence. The contextual information may thus be used by the NMT model when generating translations of the one or more words.

In some implementations of the present technology, the contextual string may be used for clarifying a topic associated with a source sentence. For example, let it be assumed that a source sentence in English is “The game is tomorrow”. It should be noted that the correct translation of the word “game” in Russian may be “ [symbol] ” or “ [symbol] ” and depends on a context in which the source sentence is used. In this example, the translation model may insert a contextual string “Soccer—” into the source sentence resulting in the following augmented source sentence “Soccer—The game is tomorrow”. As a result, the translation model may generate a following translation in Russian “ [symbol] - [symbol] [symbol] ” instead of “ [symbol] - [symbol] [symbol] ”. In this example, the contextual string inserted into the source sentence carries contextual information in a form of a topic-specific term and which is used by the translation model when translating the word “game”.

In other implementations of the present technology, the contextual string may be used for clarifying a gender of an entity in a source sentence. For example, let it be assumed that a source sentence in English is “The cat is hungry”. It should be noted that the correct translation of the word “cat” in Russian may be “ [symbol] ” or “ [symbol] ”, and the correct translation of the word “hungry” in Russian may be “ [symbol] ” or “ [symbol] ”, depending on whether the specific animal referenced in the source sentence is female or male. In this example, the translation model may insert a contextual string “She—” into the source sentence resulting in the following augmented source sentence “She—The cat is hungry”. As a result, the translation model may generate a following translation in Russian “ [symbol] - [symbol] [symbol] ” instead of “ [symbol] - [symbol] [symbol] ”. In this example, the contextual string inserted into the source sentence carries contextual information in a form of a gender-specific term and which is used by the translation model when translating the word “cat”, as well as the word “hungry”.

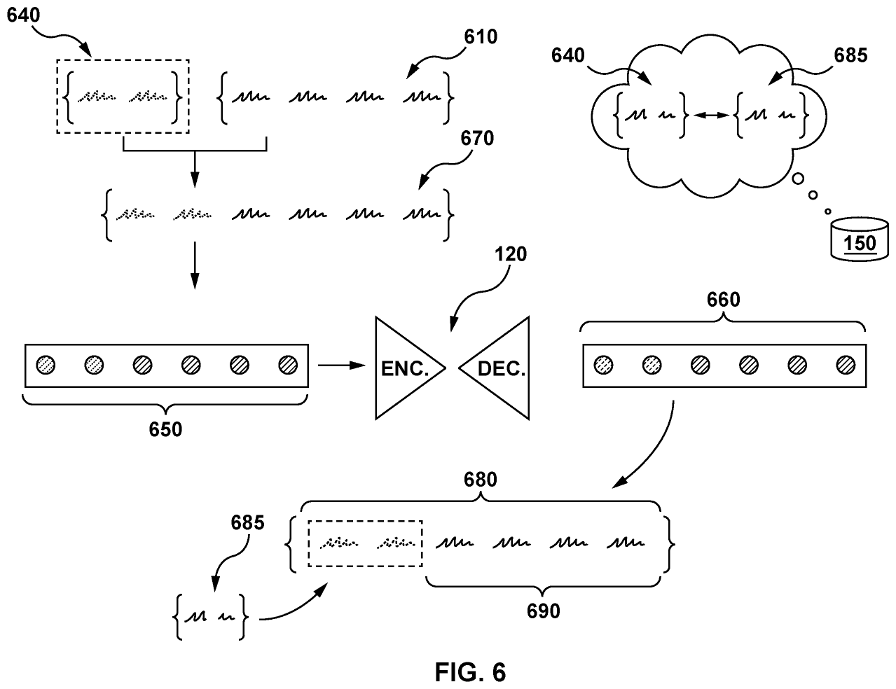

The contextual string may be provided to the translation models in different ways. In some embodiments, a server may be configured to analyze one or more other sentences from a same paragraph in which the source sentence is located. In other embodiments, a server may access information about one or more words from a repository. In further embodiments, a plurality of contextual string candidates may be pre-stored, accessed by the server, and a specific candidate may be selected by the server for insertion into a given source sentence. The specific candidate may be selected based on information acquired by the server and/or extracted from an originating source of the given source sentence. How the contextual string may be provided to the server 112 will be described in greater details herein further below with reference to FIG. 6.

Developers of the present technology have also realized that inserting the contextual string at the beginning of the sentence may be useful when processing the output from the translation model. It should be noted that inserting the contextual string at such a pre-determined position allows the translation model to identify which portion of the output sentence corresponds to the translation of the inserted contextual string. As a result, the portion of the output sentence corresponding to the translation of the inserted contextual string can be accurately removed from the target sentence to be provided as a translation of the (non-augmented) source sentence.

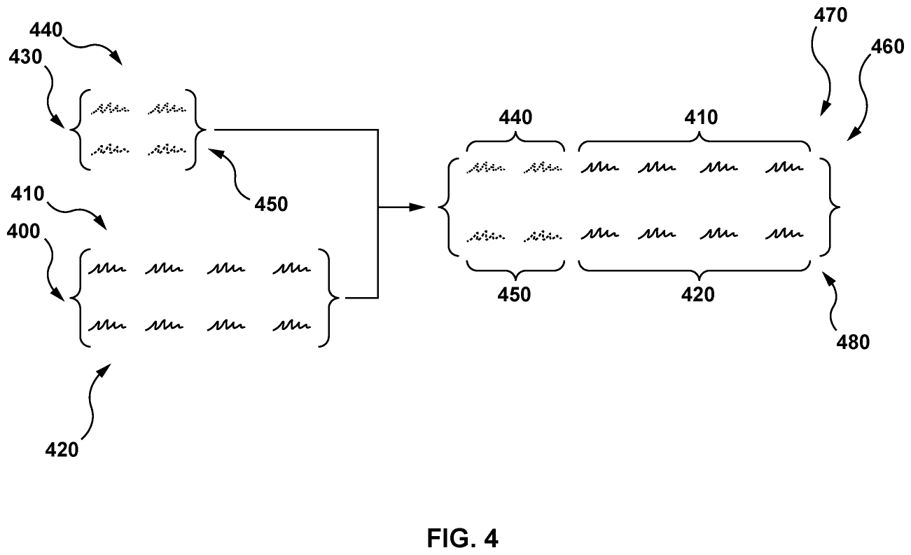

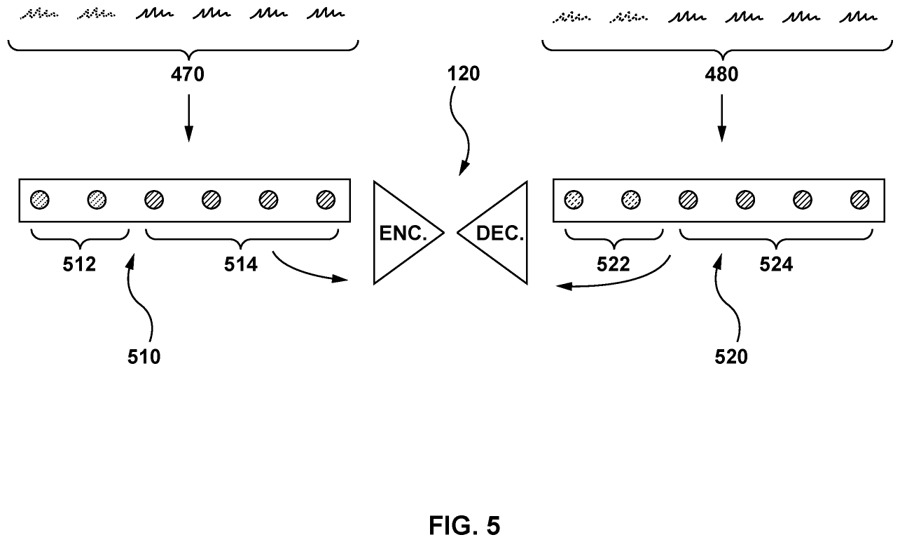

How the translation model 120 may be trained will now be described with reference to FIGS. 4 and 5. In FIG. 4, there is depicted a pair of parallel sentences 400 that the server 112 may acquire by accessing the database 150. The pair of parallel sentences 400 includes a first sentence 410 in a first language and a second (parallel) sentence 420 in a second language. There is also depicted a pair of contextual strings 430 that the server 112 may acquire by accessing the database 150. The pair of contextual strings 430 includes a first contextual string 430 and a second contextual string 440.

In this example, the server 112 is configured to augment the pair of parallel sentences 400 with the pair of contextual strings 430, thereby generating a pair of augmented sentences 460. The server 112 is configured to insert the first contextual string 440 at the beginning of the first sentence 410, and insert the second contextual string 450 at the beginning of the second sentence 420, thereby generating a first augmented sentence 470 and a second augmented sentence 480, respectively. It should be noted that the first contextual string 440 in the first augmented sentence 470 carries contextual information for one or more words in the first sentence 410, and the second contextual string 450 carries contextual information for one or more words in the second sentence 420.

In FIG. 5, there is depicted a training iteration of the translation model 120 using the pair of augmented sentences 460 as a training example. The first augmented sentence 470 is used as input into the encoder portion of the translation model 120, and the second augmented sentence 480 is used as input into the decoder portion of the translation model 120.

It should be noted that the first augmented sentence 470 and of the second augmented sentence 480 are “tokenized” when provided to the translation model 120. Broadly speaking, tokenization is a process of breaking down a piece of text, such as a sentence, into smaller units called “tokens”. A token may be a word, part of a word and/or just a character, like punctuation, for example.

As a result, the server 112 may be configured to generate a first augmented sequence of tokens 510 based on the first augmented sentence 470 and a second augmented sequence of tokens 520 based on the second augmented sentence 480. The first augmented sequence of tokens 510 includes a sub-sequence of tokens 514 corresponding to the first sentence 410 and a sub-sequence of tokens 512 corresponding to the first contextual string 440. The second augmented sequence of tokens 520 includes a sub-sequence of tokens 524 corresponding to the second sentence 420 and a sub-sequence of tokens 522 corresponding to the second contextual string 450.

It is contemplated that tokens corresponding to a given contextual string may include one or more tokens in a given augmented sequence of tokens and a number of tokens corresponding to the given contextual string may depending on inter alia various implementations of the present technology. Additional tokens to those illustrated in FIG. 5 may be included in respective augmented sequences of tokens, without departing from the scope of the present technology. For example, each augmented sequence of tokens may start and end with “special” tokens. In this example, these special tokens may include a “Beginning of Sentence” (BOS) token and a “End of Sentence” (EOS) token.

It should be noted that tokens corresponding to a given contextual string in a given augmented sequence of tokens are positioned at a pre-determined position in the given augmented sequence of tokens. As illustrated, the sub-sequence of tokens 512 is positioned at the beginning of the first augmented sequence of tokens 510 (e.g., immediately after the BOS token) and before the sub-sequence of tokens 514. Also, the sub-sequence of tokens 522 is positioned at the beginning of the second augmented sequence of tokens 520 (e.g., immediately after the BOS token) and before the sub-sequence of tokens 524.

As it will be described in greater details herein further below with reference to the in-use phase of the translation model 120, inserting contextual strings at the beginning of respective sentences may facilitate identification of a translated contextual string from the output of the translation model 120 so that it can be accurately removed from the translated sentence.

During the training iteration depicted in FIG. 5, the first augmented sequence of tokens 510 is processed by the encoder portion of the translation model 120 and the second augmented sequence of tokens 520 is processed by the decoder portion of the translation model 120.

During training, the translation model 120 is inputted with a large number of augmented training examples having been generated similarly to what has been described with reference to FIG. 4. It can be said that the translation model 120 learns to use contextual information carried by the tokens corresponding to contextual strings in the respective augmented sequences of tokens for performing context-specific translation from the first language to the second language.

With reference to FIG. 6, there is depicted an in-use iteration of the translation model 120. The server 112 is configured to acquire a first sentence 610 in a first language for translation. The server 112 is also configured to acquire a first contextual string 640.

In some embodiments, the first sentence 610 may be one of a plurality of sentences from a digital document. For example, the first sentence 610 may be a given sentence from a main body of a web page. In an other example, the first sentence 610 may be provided to the server 112 from the electronic device 104 associated with the user 102.

In other embodiments, the server 112 may be configured to identify the context in which the first sentence 610 is used based on an other one of the plurality of sentences. For example, a gender of a given entity referenced in the first sentence 610 may be provided in an other sentence from the plurality of sentences. In another example, a topic of the first sentence 610 may be provided in an other sentence from the plurality of sentences. In further embodiments, the server 112 may be configured to identify the context in which the first sentence is used based on data stored in associated with one or more word in the first sentence. In some embodiments, the server 112 may be configured to access the context-specific vocabulary 140 for selecting a given contextual string that carries information indicative of a determined context.

In one example, if it is determined that the gender of an entity referenced in the first sentence 610 is male, the server 112 may retrieve the pair of contextual strings “He—”& “oH—. In this example, the server 112 inserts the contextual string 640 “He—” at the beginning of the first sentence 610, thereby generating a first augmented sentence 670.

Tokenization of the first augmented sentence 670 is performed when the first augmented sentence is provided by the server 112 to the translation model 120. As illustrated, the first augmented sentence 670 is tokenized into an augmented sequence of input tokens 650. The translation model 120 is configured to generate a sequence of output tokens 660 based on the augmented sequence of input tokens 650. The server 112 is configured to generate an augmented output sentence 680 based on the sequence of output tokens 660.

The server 112 may identify a portion of the augmented output sentence 680 that corresponds to the translation of the contextual string 640. It should be noted that the server 112 has access to the corresponding contextual string 685 which is the translation of the contextual string 640. The server 112 may then identify a portion at the beginning of the augmented output sentence 680 that corresponds to the contextual string 685. The server 112 is configured to remove the so-identified portion from the augmented output sentence 680, thereby generating an output sentence 690.

It should be noted that although the output sentence 690 does not include the portion corresponding to the contextual string 685, one or more words in the output sentence 690 are generated based on at least in part the contextual information provided by the contextual string 685.

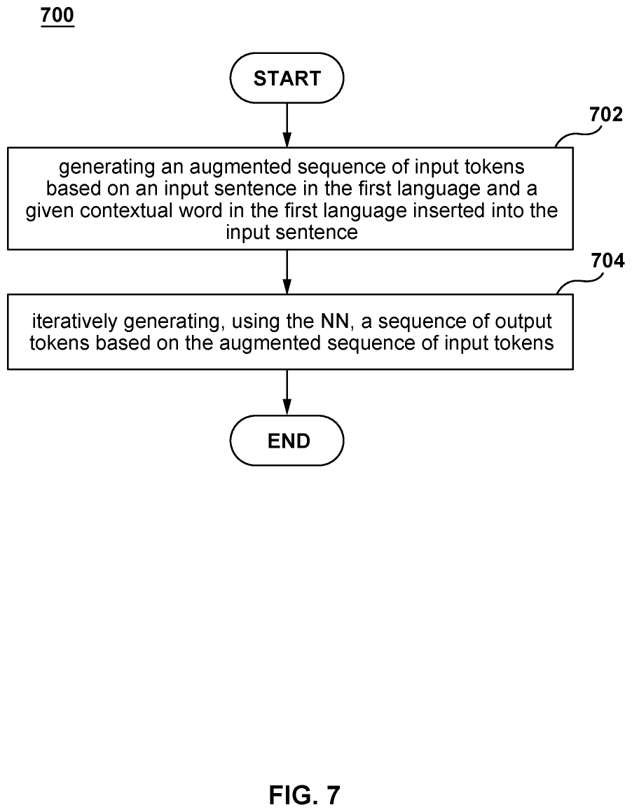

In some embodiments of the present technology, the server 112 is configured to execute a method 700 illustrated in FIG. 7. Various steps of the method 1000 will now be discussed in greater details.

STEP 702: Generating an Augmented Sequence of Input Tokens Based on an Input Sentence in the First Language and a Given Contextual Word in the First Language Inserted into the Input Sentence

The method 700 begins at step 702 with the server 112 configured to generate an augmented sequence of input tokens based on an input sentence in the first language and a given contextual word in the first language inserted into the input sentence. The given contextual word is associated with a corresponding contextual word in the second language.

The input sentence has a given word and which is represented as a first input token in the augmented sequence of input tokens. The given contextual word is represented as a second input token in the augmented sequence of input tokens. The second input token is positioned in the augmented sequence of input tokens at a pre-determined position and carrying contextual information about the first input token.

For example, a given word may be represented by one or more input tokens. In other words, it is contemplated that the first input token can be a sub-sequence of input tokens and the given word is represented by the sub-sequence of input tokens in the augmented sequence of input tokens.

It should be noted that the input sentence may be acquired from an electronic device associated with a user, and/or may be a given one from a plurality of sentences in a digital document. It is contemplated that the server may determine the given contextual word based on an other given one from the plurality of sentences.

In further embodiments, the given contextual word may be determined based on data pre-stored in associated with one or more words in the input sentence. For example, individual words and/or combinations of words may be stored in a database in associated with information indicative of a given contextual word that carries contextual information about the individual words and/or combinations of words. In additional embodiments, the server may access the context-specific vocabulary for identifying the given contextual word in the first language and the corresponding contextual word in the second language.

In some cases, the contextual information may represent a gender of a given input word. In other cases, the contextual information may represent a topic of the input sentence including the given input word.

It is contemplated that the given contextual word may be inserted at a beginning of the input sentence, resulting in the corresponding input tokens being positioned at a beginning of the augmented sequence of input tokens.

### STEP 704: Iteratively Generating, Using the NN, a Sequence of Output Tokens Based on the Augmented Sequence of Input Tokens

The method 700 continues to step 704 with the server iteratively generating, using an NN, a sequence of output tokens based on the augmented sequence of input tokens. The sequence of output tokens includes a first output token and a second output token. The second output token is positioned in the sequence of output tokens at a pre-determined position and represents the corresponding contextual word in the second language. The first output token represents a context-specific translation of the given word.

For example, since the input tokens representative the contextual word may be located at the beginning of the augmented sequence of input tokens, the NN may generate output tokens representative of the translated contextual word at the beginning of the outputted sequence of output tokens.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A method of performing context-specific translation of sentences from a first language to a second language, the method executable by a server, the server running a Neural Network (NN) and having access to a context-specific vocabulary containing contextual words in the first language and respective translations in the second language, the method comprising:
generating, by the server, an augmented sequence of input tokens based on an input sentence in the first language and a given contextual word in the first language inserted into the input sentence, the given contextual word being associated with a corresponding contextual word in the second language,
the input sentence having a given word, the given word being represented as a first input token in the augmented sequence of input tokens,
the given contextual word being represented as a second input token in the augmented sequence of input tokens, the second input token being positioned in the augmented sequence of input tokens at a pre-determined position and carrying contextual information about the first input token;
iteratively generating, by the server using the NN, a sequence of output tokens based on the augmented sequence of input tokens, the sequence of output tokens including a first output token and a second output token,
the second output token being positioned in the sequence of output tokens at a pre-determined position and representing the corresponding contextual word in the second language, the first output token representing a context-specific translation of the given word.

2. The method of claim 1, wherein the first input token is a sub-sequence of input tokens, the given word being represented by the sub-sequence of input tokens in the augmented sequence of input tokens.

3. The method of claim 1, wherein the first output token is an other sub-sequence of input tokens, the context-specific translation of the given word being represented by the other sub-sequence of input tokens.

4. The method of claim 1, wherein the input sentence is a given one from a plurality of sentences in a digital document, the method further comprising:
determining, by the server, the given contextual word based on an other given one from the plurality of sentences.

5. The method of claim 1, wherein the method further comprises:
determining, by the server, the given contextual word based on data pre-stored in association with one or more words from the input sentence.

6. The method of claim 1, wherein the method comprises accessing, by the server, the context-specific vocabulary for identifying the given contextual word in the first language and the corresponding contextual word in the second language.

7. The method of claim 1, wherein the method further comprises generating, by the server, an output sentence in the second language using the sequence of output tokens.

8. The method of claim 7, wherein the generating the output sentence comprises removing the corresponding contextual word.

9. The method of claim 1, wherein the pre-determined position in the augmented sequence of input tokens is a position preceding input tokens representing the input sentence.

10. The method of claim 1, wherein the pre-determined position in the augmented sequence of input tokens is at a beginning of the augmented sequence of input tokens.

11. The method of claim 1, wherein the pre-determined position in the sequence of output tokens is at a beginning of the sequence of output tokens.

12. The method of claim 1, wherein the NN is a transformer model, the transformer model having an encoder portion dedicated to the first language and a decoder portion dedicated to the second language.

13. The method of claim 1, wherein the contextual information represents a gender of the given input word.

14. The method of claim 1, wherein the contextual information represents a topic of the input sentence including the given input word.

15. A server for performing context-specific translation of sentences from a first language to a second language, the server running a Neural Network (NN) and having access to a context-specific vocabulary containing contextual words in the first language and respective translations in the second language, the server being configured to:
generate an augmented sequence of input tokens based on an input sentence in the first language and a given contextual word in the first language inserted into the input sentence, the given contextual word being associated with a corresponding contextual word in the second language,
the input sentence having a given word, the given word being represented as a first input token in the augmented sequence of input tokens,
the given contextual word being represented as a second input token in the augmented sequence of input tokens, the second input token being positioned in the augmented sequence of input tokens at a pre-determined position and carrying contextual information about the first input token;
iteratively generate, using the NN, a sequence of output tokens based on the augmented sequence of input tokens, the sequence of output tokens including a first output token and a second output token,
the second output token being positioned in the sequence of output tokens at a pre-determined position and representing the corresponding contextual word in the second language, the first output token representing a context-specific translation of the given word.

16. The server of claim 15, wherein the first input token is a sub-sequence of input tokens, the given word being represented by the sub-sequence of input tokens in the augmented sequence of input tokens.

17. The server of claim 15, wherein the first output token is an other sub-sequence of input tokens, the context-specific translation of the given word being represented by the other sub-sequence of input tokens.

18. The server of claim 15, wherein the input sentence is a given one from a plurality of sentences in a digital document, the server is further configured to:
determine the given contextual word based on an other given one from the plurality of sentences.

19. The server of claim 15, wherein the server is further configured to:
determine the given contextual word based on data pre-stored in association with one or more words from the input sentence.

20. The server of claim 15, wherein the server is configured to access the context-specific vocabulary for identifying the given contextual word in the first language and the corresponding contextual word in the second language.
